(19) United States
(12) Patent Application Publication
(10) Pub. No.: US 2011/0013521 A1
(43) Pub. Date: Jan. 20, 2011

(54) Locating a Fault in a Communications Network

(75) Inventors: Balaji Sankaran, Bangalore (IN); Nune Venkata Chalapathi, Bangalore (IN)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/608,520

(22) Filed: Oct. 29, 2009

(30) Foreign Application Priority Data
Jul. 15, 2009 (IN) 1678/CHE/2009

(51) Int. Cl. H04L 12/26

(52) U.S. Cl. 370/242

(57) ABSTRACT

A method for locating a fault in a communications network includes modifying the time-to-live (TTL) value in an Internet Protocol header of a data packet and transmitting the data packet through the communications network. The method continues with receiving a TTL-exceeded message from a routing element in the communications network and modifying the time-to-live value in the Internet protocol header of a second data packet, wherein the time-to-live value corresponds to a second hop count, the second hop count corresponding to the number of hops from the transmitting server to a second one of the plurality of routing elements in the communications network.

### RELATED APPLICATIONS

Pursuant to 35 U.S.C. 119(b) and C.F.R. 1.55(a), the present application corresponds to and claims the priority of Indian Patent Application No. 1678/CHE/2009, filed on Jul. 15, 2009, the disclosure of which is incorporated herein by reference in its entirety.

### BACKGROUND

In a communications network, the path between a transmitter and a destination may involve several intermediate routers and switches that convey data packets and other information through the network to the destination. On occasion, one or more of these routers or switches may fail to move the packets and other data towards the destination. In situations in which the router fails to transport any data packets, existing network management products can be used to detect the faulty element and to reroute data packets around the failed element.

However, when a router is able to transport some data packets but unable to transport other data packets, determining the precise nature of the problem can be much more challenging. In these instances, existing network tools, though useful under conditions in which no packets are transported through the router, are not effective.

### BRIEF DESCRIPTION OF THE DRAWINGS

FIG. 1 is a top-level network architecture diagram in which an embodiment of the invention may be practiced.

FIG. 2 is a flow chart for a method for locating a fault in a communications network according to an embodiment of the invention.

FIG. 3 is a block diagram of a logic module, operating in the computing environment, for locating a fault in a communications network.

### DESCRIPTION OF THE EMBODIMENTS

In the context of the present invention the term “routing element” is intended to encompass a large variety of network devices such as routers and network hubs. Thus, a routing element may take the form of a router, which connects two or more networks, and may include routing devices that can be programmed to filter out some packets and to dynamically change the route through which packets are routed. A routing element may also take the form of a device that interfaces two or more separate media on the same network, such as a network hub that might include an Ethernet port as well as an Integrated Services Digital Network (ISDN) port and may convey data between these two media.

In one example in which embodiments of the present invention may be useful, consider a network wherein a File Transfer Protocol is operating without incident; meanwhile, other services, such as Secure Shell, have become problematic in that data packets from the Secure Shell transmitter are not reaching the destination server. In this instance, conventional troubleshooting tools may be ineffective in determining that an incorrect firewall rule is being enforced at either the destination server or at a routing element in between the transmitter and the destination server. The incorrect rule enforcement is responsible for prohibiting the delivery of Secure Shell packets while allowing File Transfer Protocol packets to pass through the firewall.

In another example in which locating a fault in a communications network may be useful, consider an instance in which a Network File System file transfer results in a nonresponsive client. In this example, a Network File System client has issued a read request to a Network File System server for a large file. After the request is issued, the complete response for the request never arrives at the requesting client. Meanwhile, other Network File System commands operate without incident. In this instance, it is entirely possible that when the read request was issued to the Network File System server, the destination server responded with a very large Internet protocol (IP) packet that became fragmented into multiple (perhaps as many as 32) smaller Internet protocol packets. When these packets arrived at an intermediate routing element, the network element was not able to forward all of the Internet Protocol packets that had been received. Accordingly, the client that initiated the request had never received a complete response from the destination server. Subsequently, the requesting client remained non-responsive for an indefinite period of time.

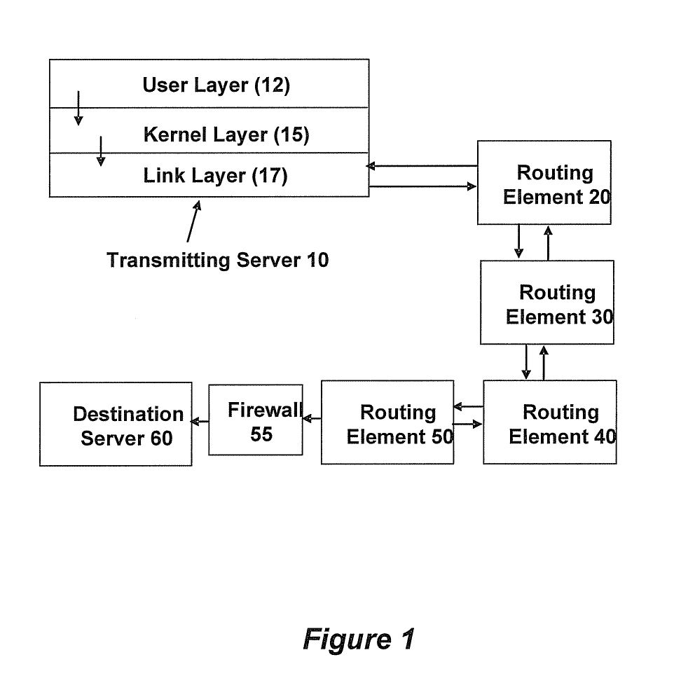

FIG. 1 is a top-level network architecture diagram in which an embodiment of the invention may be practiced. In FIG. 1, transmitting server 10 includes a software architecture having a user layer (12), a kernel layer (15), and a link layer (17). User layer 12 provides the user interface management, session management, and other top-level functions that enable the transmitting server to receive commands from the user and to display the results of the various processes to the user. Kernel layer 15 represents the operating system kernel responsible for servicing resource requests from applications and for managing the processing resources of transmitting server 10. Link layer 17, represents the physical and logical network components used to interconnect transmitting server 10 with destination server 60 by way of routing elements 20, 30, 40, and 50. Also shown in FIG. 1 is firewall 55 examines all data traffic to and from server 60 and determines if individual data packets meet certain criteria. Data packets not meeting those criteria are rejected by firewall 55.

In an embodiment of the present invention, a “time-to-live” (TTL) engine operating at the kernel layer (15) modifies the TTL value in the IP header of a first data packet. In this embodiment, a utility program which may be initiated at user layer 12, takes on the faulty program or service as an argument. In one example, the syntax used to invoke such a program might be “nwtusc {192.168.0.100}”, in which 192.168.0.100 corresponds to an exemplary Internet protocol address of destination server 60. In another embodiment of the invention in which it may be important to target packets of a particular application session, it can be useful to additionally include a port number (such as “nwtusc {192.168.0.100, [21]}”) when invoking the program. When the faulty program is run by way of the exemplary “nwtusc” program, the faulty program is spawned as a child process which passes the process ID, destination IP address, and perhaps the port number to the TTL engine operating at kernel layer 15.

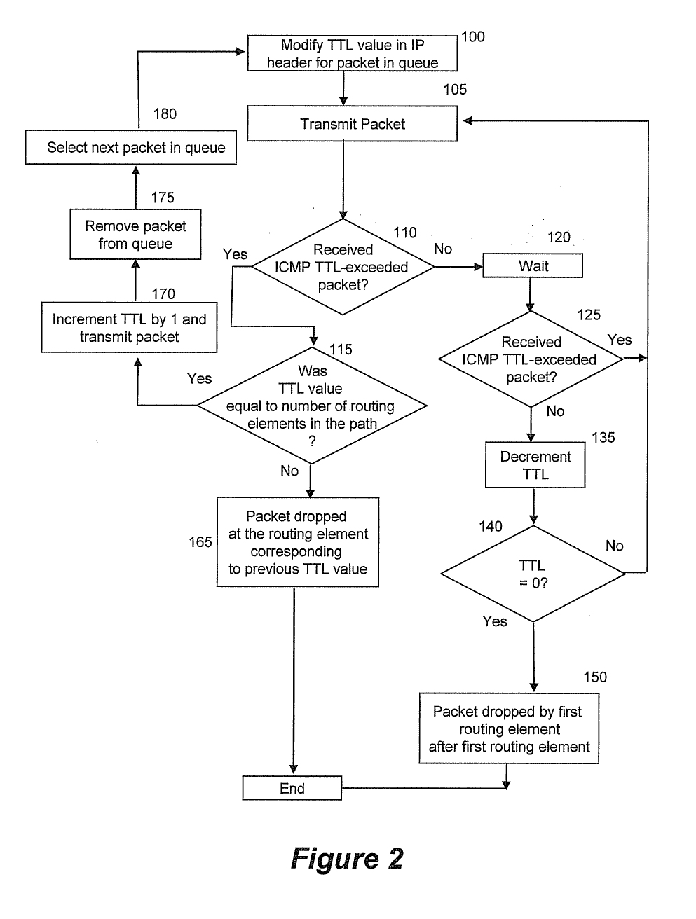

The nwtusc program finds the path (which may be a list of intermediate routers, hubs, or other network elements) taken by a packet to reach a destination server using a utility such as “traceroute”. By way of traceroute (for example), the individual routing elements and the number of hops to each routing element are passed to the TTL engine. In this embodiment, the process identification, destination Internet protocol address, and destination port number are used to identify the Internet protocol packets of the particular program experiencing the faults. The identified Internet protocol data packets are stored in a queue by the TTL engine. Thus, the TTL engine can either increment or decrement the TTL value to “tune” the time-to-live of each packet. Through this “tuning”, each routing element in between the transmitting and destination server can be tested, as will be discussed with reference to FIG. 2.

FIG. 2 is a flow chart for a method of locating a fault in a communications network according to an embodiment of the invention. The top level architecture of FIG. 1 may be used to perform the method of FIG. 2, although many other architectures may be used to perform the method. FIG. 2 begins at step 100 in which the TTL value in the Internet protocol header for the first packet in the queue is modified. In an exemplary embodiment in which 4 routing elements are located between the transmitting and receiving servers, the result of step 100 would be to set the TTL value for a hop count equal to 4. After the TTL value has been changed in step 100, step 105 is performed in which the packet is transmitted in the direction of the destination server.

The method continues at step 110 in which in the TTL engine operating at the kernel layer determines whether an Internet Control Message Protocol (ICMP) TTL-exceeded packet has been received. In the embodiment of FIG. 2, each routing element through which the packet is routed decrements the TTL value by 1. Thus, as the packet having a TTL value of 4 travels through routing element 20 of FIG. 1 (the first routing element encountered by the packet), routing element 20 sets the TTL to 3. As the packet travels through routing element 30 (the second routing element), routing element 30 sets the TTL to 2. Continuing with this example, as the packet travels through the third routing element (40), routing element 40 sets the TTL value to 1. When the packet reaches the fourth routing element (50), routing element 50 sets the TTL to 0. Upon setting the TTL to 0, routing element 50 returns an ICMP TTL data packet to the TTL engine indicating that the TTL for the transmitted message packet has been exceeded. Thus, the TTL engine is made aware that the packet has been successfully routed through each of the 4 routing elements of this example, as in step 110. (However, the packet has not reached the destination server.)

In the event that the outcome of step 110 indicates that the transmitting entity has not received an ICMP TTL-exceeded packet, step 120 is executed in which the TTL engine waits for a predetermined length of time. This waiting period allows for packet delays caused by temporary problems such as network congestion, router resets, and so forth. After waiting a predetermined period of time, step 125 is performed in which a decision is made as to whether the TTL engine has received an ICMP TTL-exceeded packet. If an ICMP TTL-exceeded packet has been received, the method returns to step 105, in which the previously-transmitted packet is transmitted a second time. By transmitting a second time, it can be determined whether or not the network is still experiencing temporary problems.

In the event that the decision of step 125 indicates that the TTL engine has not received an ICMP TTL-exceeded packet, step 135 is performed in which the value of the TTL is decreased (such as, for this example, from 4 to 3.) The method then continues at step 105 in which the packet is retransmitted using the new value for TTL.

To briefly illustrate how the method of FIG. 2 can be used to identify a fault location in a network, when the value for TTL has been set to 4, and an ICMP TTL-exceeded packet has not been received, it is possible that routing elements 20, 30, 40, or 50 are faulty. To locate the routing element that has experienced the fault, the previously-transmitted packet is resent using a value for TTL of 3. If the TTL engine subsequently receives a ICMP TTL-exceeded packet (from routing element 40), then the TTL engine can be made aware that routing element 50 is faulty.

Continuing with the example of FIG. 2, in the event that the method has progressed through several iterations, perhaps beginning with a value for TTL of 4, then 3, then 2, then 1, as each value is decremented by way of step 135, the decision of step 140 would indicate that the hop count is now equal to 0. If indeed the hop count is equal to 0, then the TTL engine can be made aware (in step 150) that packets are being dropped by the first routing element in the path.

Returning now to decision block 110 of FIG. 2, in the event that the decision of step 110 indicates that the TTL engine has received an ICMP TTL-exceeded packet, step 115 can be performed. If the outcome of step 115 indicates that the current TTL value is equal to the number of routing elements in the path, step 170 can be performed in which the TTL value is incremented by 1 and the packet is transmitted again. The rationale for step 170 is that if the TTL value was indeed set to a number equal to the number of routing elements in the path, as determined by the decision of step 115, then the previously-transmitted packet should indeed be able to reach the destination server. Accordingly, in step 170, the TTL value is incremented so that the packet can be transmitted through the network to the destination server.

After step 170 is performed, step 175 can be performed in which the packet is removed from the queue of the TTL engine. The removal of this packet from the queue of the TTL engine follows from the assumption that the packet has been successfully transmitted to the destination server, as in step 170. After performing step 175, step 180 can be performed in which the next packet in the queue of the TTL engine is selected. The method then returns to step 100 in which the TTL value for the IP header of the next packet is set to the maximum number of routing elements in the network path (which, in this example, might be 4).

In the event that the decision of step 115 indicates that the TTL value is not equal to the number of routing elements in the path of the data packet, step 115 is performed in which the TTL engine is informed that the packets are being dropped at the routing element corresponding to the previous hop count. Thus, in this example, if a transmitted message having a TTL value of 3 has not resulted in the TTL engine receiving an ICMP TTL-exceeded packet (outcome of step 110 is “no”) but a TTL value of 2 resulted in a “yes” outcome of step 110, then the TTL engine would recognize that the fault is occurring at the routing element corresponding to the previous TTL value (3), as in step 165.

When the method of FIG. 2 terminates, the TTL engine is notified to stop the TTL tuning. Upon receiving the notification, the TTL engine does not accept any new packets into the TTL queue. However, for those packets already in the queue, the method continues until those packets have been evaluated.

An advantage of the method of FIG. 2 is that the particular data packets of the actual application are being used. This is in contrast to more conventional troubleshooting techniques in which data packets from a testing tool (which includes no actual application data) are used. Thus, in the instance of a previously-identified failure condition, in which Secure Shell packets were not allowed to pass while File Transfer Protocol packets were allowed to pass through a network firewall (such as firewall 55 of FIG. 1) by using data packets from the actual applications, the response of each routing element in the path between the transmitter and receiver under real-world conditions can be assessed.

An additional advantage of the method of FIG. 2 is that step 100 begins by setting the TTL value to the hop count of the number of routing elements in the data path. By setting the initial TTL value to the final hop count and then reducing the TTL value, an undesirable situation can be avoided. To illustrate this, consider the example of a faulty firewall between routing element 50 and destination server 60 of FIG. 2. With the initial TTL value set to 1, Transport Control protocol handshaking packets, such as Synchronization (SYN) packets would be transmitted to destination server 60 4 times as the method steps through testing routing element 20, routing element 30, routing element 40, and routing element 50. In contrast, by starting with a TTL value equal to the total number of routing elements in the data path, the method of FIG. 2 would have ascertained that the fault was located after routing element 50 after only 2 TTL-tuned packet was transmitted. Accordingly, it can be seen that by setting the initial hop count to the total number of routing elements in the data path, unnecessary transmissions can be avoided.

The method of FIG. 2 can be encoded using any type of computer-readable media which, when executed by a computer, causes the computer to perform the method. The term “computer-readable media” is intended to encompass a multitude nonvolatile memory devices memory devices such as compact discs, digital versatile discs, flash drives, and so forth. Further, computer-readable media can also include memory structures internal to computing devices such as flash memory, random access memory, read-only memory, computer hard drives, and so forth.

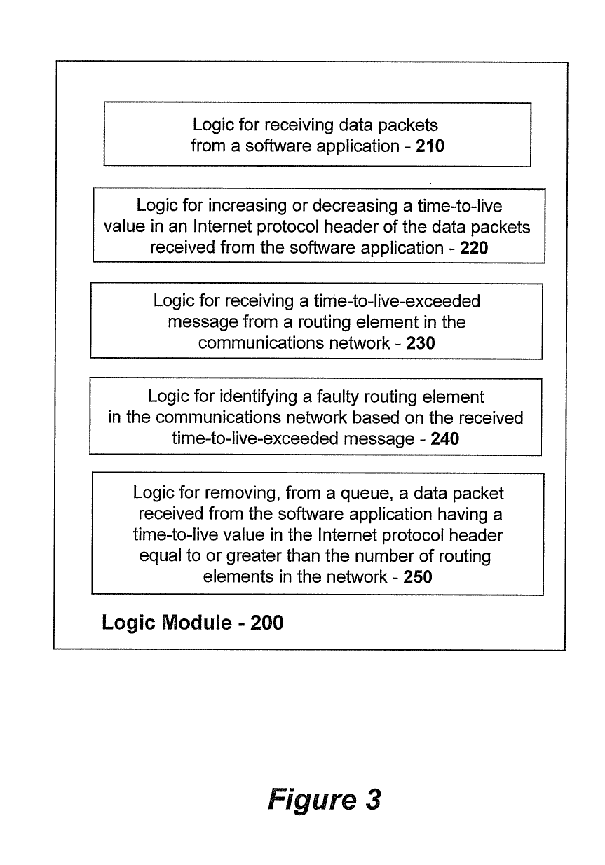

FIG. 3 is a block diagram of a logic module, operating in a computing environment, for locating a fault in a communications network. Logic module 200 includes logic for receiving data packets from a software application (210). Logic module 200 also includes logic for increasing or decreasing a TTL value in an Internet protocol header of the data packets received from the software application (220). The logic module also includes logic for receiving a TTL-exceeded message from a routing element in the communications network (230). In accordance with embodiments of the invention, these TTL-exceeded messages are indications that a data packet has reached at least one of the routing elements that lie between a transmitting server and a destination server, such as transmitting and destination servers 10 and 60 of FIG. 1. Logic module 200 also includes logic for identifying a faulty routing element in the communications network based on the received TTL-exceeded message (240). In some embodiments of the invention, logic module 200 also includes logic for removing, from a queue, a data packet received from the software application having a TTL value in the Internet protocol header equal to or greater than the number of routing elements in the network (250).

It is noteworthy to indicate that the embodiments of the invention disclosed herein may not be useful in determining why particular message packets are being dropped by the various routing elements between the transmitting and destination servers. In the embodiments of the invention, the only determination that has been made is the location along the path at which packets have been dropped. Accordingly, embodiments of the invention may be used in conjunction with other diagnostic tools that determine why particular routing elements are not allowing packets to proceed in the direction of the destination server.

In conclusion, while the present invention has been particularly shown and described with reference to various embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

What is claimed is:

1. A method for locating a fault in a communications network, comprising:
modifying a time-to-live value in an Internet protocol header of an application data packet, the time-to-live value corresponding to a hop count from a transmitting server to one of a plurality of routing elements in the communications network;
transmitting, by the transmitting server, the application data packet through the communications network;
receiving a time-to-live-exceeded message from the one of the plurality of routing elements in the communications network; and
modifying the time-to-live value in the Internet protocol header of the application data packet, wherein the modified time-to-live value corresponds to a second hop count, the second hop count corresponding to the number of hops from the transmitting server to a second one of the plurality of routing elements in the communications network.

2. The method of claim 1, further comprising the transmitting server waiting to receive a second time-to-live-exceeded message from the one of the plurality of routing elements in the communications network, the waiting step occurring after before the second modifying step.

3. The method of claim 2, further comprising the transmitting server decrementing the time-to-live value prior to the second modifying step.

4. The method of claim 2, further comprising the transmitting server incrementing the time-to-live value prior to the second modifying step.

5. The method of claim 4, wherein the transmitting server increments the time-to-live value to a number equal to the number of routing elements present in the communications network, and wherein the transmitting server removes the packet from a message queue.

6. A logic module in a server for locating a fault in a communications network, comprising:
logic for receiving data packets from a software application;
logic for increasing or decreasing a time-to-live value in an Internet protocol header of the data packets received from the software application;
logic for receiving a time-to-live-exceeded message from a routing element in the communications network; and
logic for identifying a faulty routing element in the communications network based on the received time-to-live-exceeded message.

7. The logic module of claim in 6, further comprising logic for decreasing the time-to-live value in the Internet protocol header of the data packets received from the software application.

8. The logic module of claim 7, wherein the logic for decreasing the time-to-live value in the Internet protocol header of the data packets received from the software application includes logic for determining that a previously-transmitted data packet did not result in receiving a time-to-live-exceeded message.

9. The logic module of claim 6, wherein the logic for increasing or decreasing the time-to-live value in the Internet protocol header of the data packets received from the software application is coupled to logic that:
increases the time-to-live value of the Internet protocol header of a data packet if a time-to-live-exceeded message has been received; and
decreases the time-to-live value of the Internet protocol header of a data packet if a time-to-live-exceeded message has not been received.

10. The logic module of claim 6, further comprising logic for removing, from a queue, a data packet received from the software application having a time-to-live value in the Internet protocol header equal to or greater than a number of routing elements in the communications network.

11. A computer that determines the location of a fault in a communications network, comprising:
means for modifying a time-to-live value in an Internet protocol header of an application data packet;
means for determining if a time-to-live-exceeded message has been received from a routing element in the communications network;
means for incrementing the time-to-live value in the Internet protocol header of the application data packet when the time-to-live-exceeded message has been received, and;
means for decrementing the time-to-live value in the Internet protocol header of the application data packet when the time-to-live-exceeded message has not been received.

12. The computer of claim 11, wherein the means for modifying the time-to-live value is performed at a kernel layer.

13. The computer of claim 11, further comprising means for removing the application data packet from a message queue when a previous transmission of the application data packet having a time-to-live value in an Internet protocol header equal to or greater than the number of routing elements in the network results in a time-to-live-exceeded message being received.

14. The computer of claim 11, further comprising means for retransmitting the application data packet after the time-to-live value in the Internet protocol header of the application data package has been incremented or decremented.

15. The computer of claim 11, wherein the means for modifying a time-to-live value in an Internet protocol of an application data packet initially sets the time-to-live value to correspond to the number of routing elements between the transmitting and the destination server.
